(19) United States
(12) Patent Application Publication
(10) Pub. No.: US 2006/0095257 A1
(43) Pub. Date: May 4, 2006

(54) Method of generating program parameters according to decibel levels of voice signals

(76) Inventors: Yuan-Horng Tsai, Kaohsiung (TW); Ting-Jr Chen, Kaohsiung (TW)

Correspondence Address: Troxell Law Office PLLC, Suite 1404, 5205 Leesburg Pike, Falls Church, VA, 22041, US

(21) Appl. No.: 10/979,237

(22) Filed: Nov. 3, 2004

(51) Int. Cl. G10L 11/06

(52) U.S. Cl. 704/210

(57) ABSTRACT

The method of generating program parameters based on decibel levels of voice signals. The method first creates a database including a table has degrees, decibel ranges and program parameters. Each decibel range is corresponding to a specific program parameter. When a voice signal is received, the method will determine the magnitude of the decibel level of the input voice signal. Then, the method will read the database to respectively compare the present decibel level with the decibel ranges to find which if any, decibel range matches the present decibel level. If there a decibel range is found, the program parameter corresponding to the decibel range will be output.

### BACKGROUND OF THE INVENTION

1. Field of the Invention

The present invention relates to a method of generating program parameters and more particularly to a method of generating program parameters based on different decibel levels of the voice signals.

2. Description of Related Art

Most electrical products require an input device to start or close the functions of the electric product. For example, a computer basically has a mouse and a keyboard to input commands or control the cursor on the screen. Despite time and resources devoted to refining hand-held devices, problems still remain and so inconvenience is experienced. Therefore, a hands-free input device has been developed to control or select the functions of the electric product. The hands-free input device is a voice control technique so the user need only say some specific words and the function of the electric product is executed. Therefore, hands are not necessary to operate the electric product once it is actuated.

For example, one treadmill having a voice-control function includes a command recording unit, a memory device, a voice receiver and a voice identification unit. The command recording unit is used to record the command words said by the user and store the command words in the memory. When a specific command word is used, the voice receiver will receive the command word said from the user and then output the command word to the voice identification unit. Then, the voice identification unit will readout the command words from the memory recording unit to compare the received command word with the command words in the memory. If one command word in the memory matches the received command word the command corresponding to the command voice will be output to control the specific function. Therefore, the user can say the specific words to control the treadmill's function. However, in present digital circuits are used to first implement the voice identification technique so the command words are first digitized and then store digital command words in the memory. However, the command word, which is input to the voice identification unit is easily distorted since the command word the user said is processed through the voice receiver first. Therefore, the voice identification unit does not easily identify the identical command word.

Based on the foregoing description, the voice-control technique is a very convenient input means, but the identification accuracy is not good enough. However, some electrical products do not need a high-accuracy voice identification technique to achieve the voice-control function, and instead different strengths of the voice signals to achieve the voice-control function. Therefore, the present invention provides a method of generating program parameters based on the voice strength of the user. The program engineer uses the program parameters as control variable to achieve the voice-control function.

### SUMMARY OF THE INVENTION

The main objective of the present invention is to provide a method of generating program parameters based on the strength changes of the voice signals. That is, different strengths of the voice signals received in the method in accordance with the present invention will output corresponding program parameters. The program engineer uses the output program parameters as program variable to control functions of the electrical product, so the electrical product has a voice-control function.

The method of generating program parameters based on strength of voice signals in accordance with the present invention first creates a database including a table consisted of degrees, decibel ranges and program parameters. Each decibel range is corresponding to a specific program parameter. When a voice signal is received, the method will determine the strength of the input voice signal. Then, the method will read the database to respectively compare the present decibel with the decibel ranges to find which decibel range matches the present decibel. If a decibel range is found, the program parameter corresponding to the decibel range will be output. Therefore, if the program engineer uses the program parameter as the program variable of the appropriate program, the electrical product has a voice-control function.

Other objectives, advantages and novel features of the invention will become more apparent from the following detailed description when taken in conjunction with the accompanying drawings.

### BRIEF DESCRIPTION OF THE DRAWINGS

FIG. 1 is table of a preferred embodiment created in a database of a method of generating program parameters in accordance with the present invention;

FIG. 2 is a flow chart of the method of generating program parameters in accordance with the present invention;

FIG. 3 is a frame showing a video game in which the method of generating program parameters is applied;

FIG. 4 is a computer screen shown a moving cursor controlled by the method of generating program parameters in accordance with the present invention; and

FIG. 5 is an electrical door lock in which the method of generating program parameters is applied.

### DETAILED DESCRIPTION OF THE PREFERRED EMBODIMENT

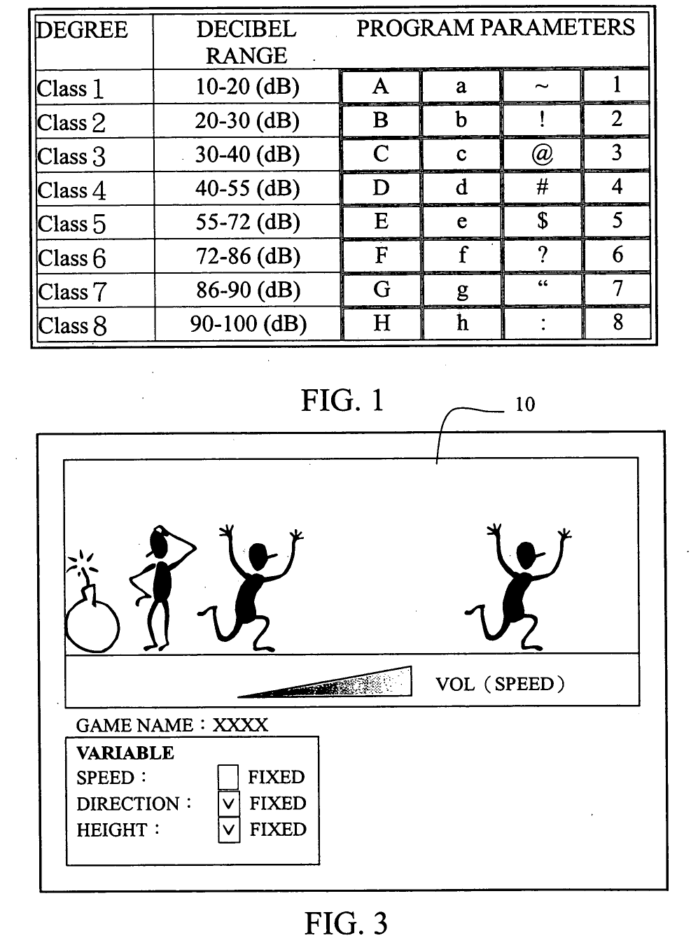

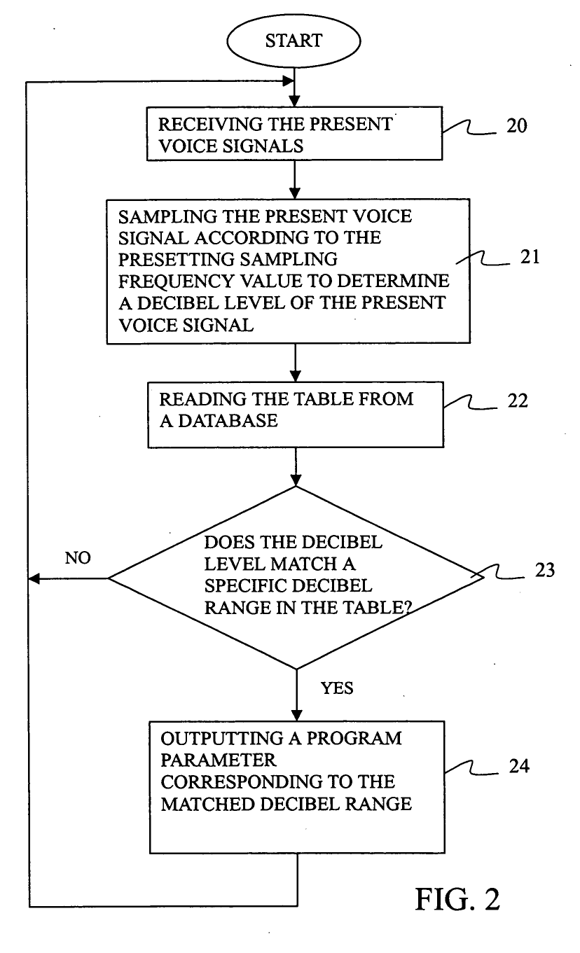

With reference to FIGS. 1 and 2, a method of generating program parameters based on the strengths of voice signals is shown. The strength of each voice signal is represented decibel. The method first creates a database creates a table comprising decibel ranges and program parameters, each of which is corresponding to one range of decibels and presets a sampling frequency value. Each range of the decibels is able to be reset, and the program parameters in the table are able to be defined with different codes by the program engineer. The sampling frequency value is able to be published for user to re-define. The method further has steps of:

(a) receiving a present voice signal (20);

(b) sampling the present voice signal according to the preset sampling frequency value to determine a decibel level of the present voice signal (21);

(c) reading a table from a database (22);

(d) comparing the decibel level with the decibel ranges in the table to find whether the decibel level matches one of the decibel ranges, wherein if there is a match, the next step is executed; on the contrary, if the decibel does not match any one decibel range the step (a) will be re-executed (23); and

(e) outputting a program parameter corresponding to the matched decibel range from the table (24).

Based on the foregoing description, the present invention generates different program parameters based on the voice signals with different decibel levels. The method of the present invention determines the decibel level of the input voice signal and then finds the program parameter corresponding to the decibel level by comparing the decibel level with the decibel ranges in the table. Therefore, a program engineer uses the program parameters as a program variable for a controlling program such that an electrical product will have a voice-control function. In addition, the engineer can set the ranges of the decibel in the table and choose the program codes matched the controlling program of the electrical product.

With reference to FIG. 3, the method in accordance with the present invention is applied to a video game (10). In general, an input device of the video game is a roller or a keyboard, so if the video game uses the voice-control input device, the video game (10) will be different and more fun. The video game (10) has three variables, i.e. speed, direction and height. If the player selects two of the variables to be fixed and the other one is changed according to output program parameters of the method, the game player can voice-control the video game (10). One possible way to play the video game (10) is as follows. When the player makes oral sound louder, the speed will be increased. On the contrary, the speed will be decreased if the player makes quieter oral sounds.

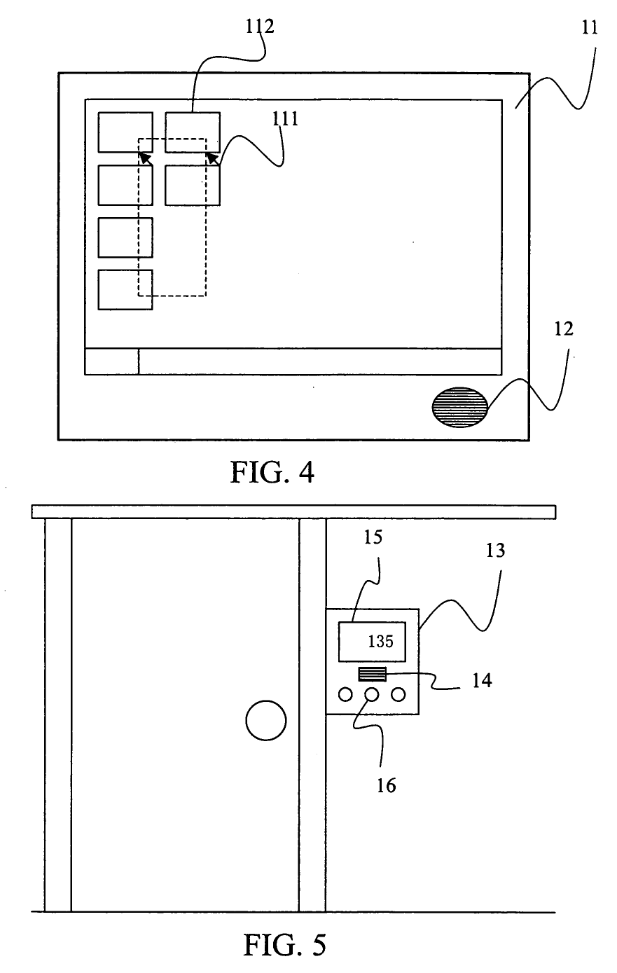

With reference to FIG. 4, the method in accordance with the present invention is applied to a control a computer's cursor (111). In general, the computer has a microphone (12) and an audio interface card to receive voice or sound signals. The program engineer can readout the voice or sound signals from the microphone and an audio interface card easily. Therefore, the program parameters generated by the present invention can be used as controlled variables for a cursor-control program. One possible way to control the cursor by the method in accordance with the present invention is to keep the cursor (111) moving along the function buttons (112) on a screen (11) while the user does not need to actuate any function button (112). If the user wants to actuate a specific function button (112) on the screen (11), the user makes a sound with a specific decibel level to stop the moving cursor (111) on a specific function button (112) and then actuates the specific function button (112). Since the method of the present invention generates a specific program parameter based on the corresponding decibel level of the voice or sound signal, if the user makes a voice or sound and the decibel level of the voice matches the specific range of the decibel in the table, the specific program parameter will be output. The cursor-control program will make the cursor stop and then actuate the function button on which the cursor is when the specific program parameter is input.

With reference to FIG. 5, the method in accordance with the present invention is applied to an electrical door lock (13). In general, the electrical door lock (13) has many different type mechanisms, such as a number keyboard lock or keycard lock etc. Therefore, if the electrical door lock (13) is further set up with a microphone (14), the electric door lock (13) can use the method of the present invention as a voice-input device. That is, the program parameters are used to correspond to numbers of the keyboard. If one key number are “135”, the user makes three voice tones with different decibel levels. The method generates three different program parameters, and the lock-control program will obtain three numbers according to the program parameters. If the key number is correct the electrical door lock (13) will open. In addition, the electrical door lock also further sets a display (15) and a button (16). The display (15) shows the number when the user makes one voice tone. If the user checks the number and finds it is correct on the display, the user can push the button (16) and then the electrical door lock (13) will accept this number. When the user inputs all numbers of the key number, the electrical door lock (13) starts to check the connection of the key number. Since the voice-control lock does not touch the lock or brush the card, the security is higher than the conventional lock.

In addition, the program parameters are also able to be used as controlled commands of general electrical products That is, each program parameter is represented by a function key of the electrical product whereby the electrical product can have a voice-control function.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method of generating program parameters, first creating a database having a table comprising decibel ranges and program parameters, each of which is corresponding to one decibel range and presetting a sampling frequency value, wherein the method comprises steps of:
(a) receiving a present voice signal;
(b) sampling the present voice signal according to the preset sampling frequency value to determine a decibel level of the present voice signal;
(c) reading a table from the database;
(d) comparing the decibel level with the decibel ranges in the table to find whether the decibel level matches one of the decibel ranges, wherein if there is one matched decibel range the next step is executed; on the contrary, if the decibel does not match any one decibel range the step (a) will be re-executed; and
(e) outputting a program parameter corresponding to the matched decibel range from the table.

2. The method of generating program parameters as claimed in claim 1, wherein the decibel ranges and program parameters are publish for user to re-define.

3. The method of generating program parameters as claimed in claim 1, wherein the program parameters are used as controlled variables of a game program.

4. The method of generating program parameters as claimed in claim 1, wherein the program parameters are used as controlled variables of a cursor controlled program.

5. The method of generating program parameters as claimed in claim 1, wherein the program parameters are used as numbers of an electronic lock.

6. The method of generating program parameters as claimed in claim 1, wherein the program parameters are used as commands of function keys of an electrical product.

7. The method of generating program parameters as claimed in claim 2, wherein the program parameters are used as controlled variables of a game program.

8. The method of generating program parameters as claimed in claim 2, wherein the program parameters are used as controlled variables of a cursor controlled program.

9. The method of generating program parameters as claimed in claim 2, wherein the program parameters are used as numbers of an electronic lock.

10. The method of generating program parameters as claimed in claim 2, wherein the program parameters are used as commands of function keys of an electrical product.
